(19) United States
(12) Patent Application Publication
(10) Pub. No.: US 2023/0011624 A1
(43) Pub. Date: Jan. 12, 2023

(54) METHOD, APPARATUS AND STORAGE MEDIUM FOR COMMUNICATION FAILURE PROCESSING

(71) Applicant: BEIJING XIAOMI MOBILE SOFTWARE CO., LTD., Beijing (CN)

(72) Inventor: Xiaowei JIANG, Beijing (CN)

(73) Assignee: BEIJING XIAOMI MOBILE SOFTWARE CO., LTD., Beijing (CN)

(21) Appl. No.: 17/782,633

(22) PCT Filed: Dec. 6, 2019
(86) PCT No.: PCT/CN2019/123824

§ 371 Date: Jun. 3, 2022

(51) Int. Cl. H04W 76/18; H04W 16/14; H04W 76/20

(52) U.S. Cl. CPC H04W 76/18; H04W 16/14; H04W 76/20

(57) ABSTRACT

Communication failure processing methods, communication failure processing apparatuses and storage media are provided. A communication failure processing method applied to a terminal may include: determining occurrence of a communication failure; and sending coexistence interference indication information for indicating a communication failure related to a coexistence interference problem. A communication failure processing method applied to a network device includes: receiving coexistence indication information for indicating a communication failure related to a coexistence interference problem of a terminal when a communication failure occurs; performing a network optimization based on the coexistence interference indication information.

### CROSS-REFERENCE TO RELATED APPLICATION

The present application is a U.S. National Stage of International Application No. PCT/CN2019/123824 filed on Dec. 6, 2019, the entire content of which is incorporated herein by reference for all purposes.

### TECHNICAL FIELD

The present disclosure relates to communication technologies, and in particular to methods, apparatuses and storage media for communication failure processing.

### BACKGROUND

Along with the development of communication technologies, terminals support more and more communication protocols. For example, the terminals may support radio communication protocols such as Long Term Evolution (LTE) and new radio (NR), as well as communication protocols performing communications by using Industrial Scientific Medical (ISM) Band such as Wireless Fidelity (Wi-Fi), Bluetooth, Global Navigation Satellite System (GNSS) modules and the like.

When a terminal supporting multiple communication protocols performs communication, there may be a problem of In Device Coexistence (IDC) interference occurring between LTE/NR frequency band communication and ISM frequency band communication. The IDC interference problem may cause the terminal to fail in communication, for example, fail in the random access procedure or small data packet transmission. In this case, a network device is not clear whether to optimize the cell coverage or to optimize the IDC interference problem, bringing difficulties to network optimization.

### SUMMARY

The present disclosure provides methods, apparatuses, and storage media for communication failure processing.

According to a first aspect of the present disclosure, a communication failure processing method is provided and includes: determining occurrence of a communication failure; and sending coexistence interference indication information for indicating the communication failure related to a coexistence interference problem.

According to a second aspect of the present disclosure, a communication failure processing method is provided. The communication failure processing method is applied to a network device and includes: receiving coexistence interference indication information for indicating a communication failure related to a coexistence interference problem of a terminal; and performing a network optimization based on the coexistence interference indication information.

According to a third aspect of the present disclosure, a communication failure processing apparatus is provided. The communication failure processing apparatus is applied to a terminal and includes: a processor; and a memory storing processor-executable instructions; when the processor executes the processor-executable instructions, the processor is configured to perform operations including: determining occurrence of a communication failure; and sending coexistence interference indication information for indicating the communication failure related to a coexistence interference problem.

It should be understood that the above general descriptions and subsequent detailed descriptions are merely illustrative and explanatory rather than limiting of the present disclosure.

### BRIEF DESCRIPTION OF THE DRAWINGS

The accompanying drawings illustrate examples consistent with the present disclosure and serve to explain the principles of the present disclosure together with the description.

FIG. 1 is an architecture diagram illustrating a communication system according to an example of the present disclosure.

FIG. 2 is a flowchart illustrating a communication failure processing method according to an example of the present disclosure.

FIGS. 3A and 3B are flowcharts illustrating a communication failure processing method according to an example of the present disclosure.

FIG. 4 is an interaction flowchart illustrating a communication failure processing method according to an example of the present disclosure.

FIG. 5 is a block diagram illustrating a communication failure processing apparatus according to an example of the present disclosure.

FIG. 6 is a block diagram illustrating a communication failure processing apparatus according to an example of the present disclosure.

FIG. 7 is a block diagram illustrating an apparatus according to an example of the present disclosure.

FIG. 8 is a block diagram illustrating an apparatus according to an example of the present disclosure.

### DETAILED DESCRIPTION

Embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The present disclosure may include the following beneficial effects: when a communication failure occurs, coexistence interference indication information may be sent, where the coexistence interference indication information indicates a communication failure related to a coexistence interference problem; thus, a network device can determine whether the communication failure is caused by the coexistence interference problem based on the coexistence interference indication information, so as to perform a network optimization based on corresponding network optimization method, thus improving the communication efficiency.

The method may be applied to a radio communication system shown in FIG. 1. As shown in FIG. 1, a terminal accesses a network via a network device such as a base station, and the network device and a core network complete backward and forward transmissions of data so as to provide various communication services.

It may be understood that, the radio communication system is a network providing radio communication function. The radio communication system may adopt different communication technologies such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), and Carrier Sense Multiple Access with Collision Avoidance. According to factors such as capacities, rates and delays of different networks, networks may be classified as a 2nd-generation (2G) network, a 3G network, a 4G network and a future evolutionary network, for example, a 5G network. The 5G network may also be referred to as a New Radio (NR) network. For convenience of descriptions, in the present disclosure, the radio communication network may sometimes be referred to as a network or system. In the present disclosure, the network may include a Radio Access Network (RAN) and a Core Network (CN). The network may include network devices, which may be, for example, a radio access network node, a core network device, and the like, where the radio access network node may also be referred to as a base station. The network may provide network services to a terminal through one or more network devices. Different operators can provide different network services to the terminal, that is, different operators correspond to different operator networks.

A terminal may also be referred to as a user equipment (UE), a mobile station (MS), a mobile terminal (MT), and the like, which is a device capable of providing voice and/or data connectivity to a user. For example, the terminal may be a handheld device or a vehicle-mounted device having wireless connection function or the like. Some examples of the terminal are a mobile phone, a Pocket Personal Computer (PPC), a palm computer, a Personal Digital Assistant (PDA), a laptop computer, a tablet computer, a wearable device, a vehicle-mounted device, or the like.

The radio communication system shown in FIG. 1 may include a plurality of terminals. The present disclosure is applicable to a case that one terminal supports, at the same time, LTE/NR communication and Wi-Fi/Bluetooth/GNSS modules using ISM frequency bands. The terminal may perform LTE/NR communication with the network device or perform ISM frequency band communication using Wi-Fi/Bluetooth/GNSS modules. When the terminal communicates with the network device, the terminal may fail to communicate due to a problem of cell coverage, or the terminal may fail to receive signals correctly and work normally due to mutual interference between LTE/NR and ISM frequency bands during signal transmission/reception.

In related arts, for the interference problem between LTE and ISM frequency bands in a terminal, LTE technology introduces an In Device Coexistence (IDC) interference optimization method. When an IDC interference occurs in a terminal and the terminal cannot solve it by itself, the terminal may report coexistence interference indication information to a network. The coexistence interference indication information may include which frequency bands are affected, an interference direction (e.g., LTE interferes with ISM, or ISM interferences with LTE, or mutual interference), and further include, for uplink carrier aggregation and multi-RAT dual connectivity, those affected carrier combinations (e.g., intermodulation interference or harmonic interference). At the same time, the terminal may also report Time-Division Multiplexing (TDM) auxiliary information, such that the network can select proper parameters in a case of using a TDM solution. The coexistence interference problem reported by the terminal may be an ongoing coexistence interference, or a coexistence interference anticipated to occur in the future. After receiving the coexistence interference indication from the terminal, the network may solve the coexistence interference problem by using TDM or Frequency Division Multiplexing (FDM) solutions.

When a communication failure occurs due to a cell coverage problem, a terminal may report a communication failure report and a network device may perform a network optimization using a cell coverage optimization method to alleviate the communication failure problem. However, when a communication failure occurs at the terminal due to coexistence interference, the network device cannot determine whether the communication failure is caused by the cell coverage problem or by a coexistence interference problem. Thus, the network device is not clear whether a cell coverage optimization or a coexistence interference problem optimization is carried out. For example, for a terminal in an idle state or an inactive state, when a Wi-Fi/Bluetooth service has a higher priority, the terminal may not suspend the service on the Wi-Fi/Bluetooth side to guarantee a random access procedure or a small data packet transmission procedure on the LTE/NR side triggered by a lower priority service. In this case, the coexistence interference problem may lead to a failure of the random access procedure or a failure of the data packet transmission.

At present, the communication failure report reported by the terminal for communication failure does not indicate whether the communication failure is related to the coexistence interference problem. Furthermore, the network device cannot determine whether the communication failure is caused by a cell coverage problem or by a coexistence interference problem. Thus, the network cannot determine to perform a cell coverage optimization or a coexistence interference problem optimization, and a network optimization method for the coexistence interference problem is different from a network optimization method for the cell coverage problem.

In view of this, examples of the present disclosure provide a communication failure processing method. When a communication failure occurs, a terminal sends a coexistence interference indication information representing whether a coexistence interference problem is existed. A network device receives the coexistence interference indication information and determines whether the communication failure is caused by a cell coverage problem or by the coexistence interference problem based on the coexistence interference indication information, and thus determines to perform a cell coverage optimization or a coexistence interference problem optimization, in this way, the communication efficiency may be improved.

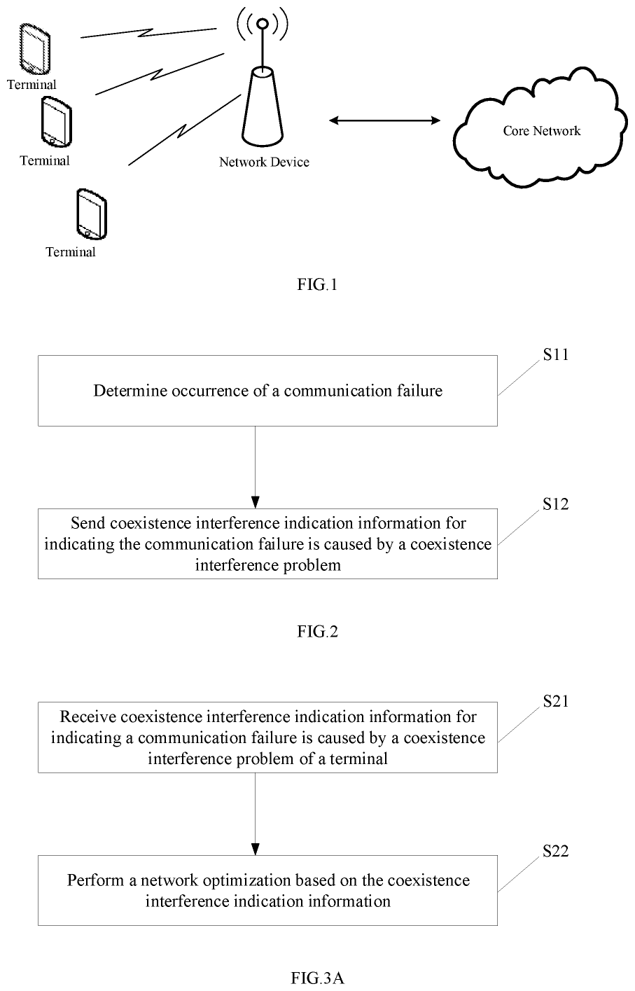

FIG. 2 is a flowchart illustrating a communication failure processing method according to an example of the present disclosure. As shown in FIG. 2, the communication failure processing method is applied to a terminal and includes the following steps.

At step S11, occurrence of a communication failure is determined.

At step S12, coexistence interference indication information is sent, where the coexistence interference indication information is used to indicate the communication failure is caused by a coexistence interference problem.

In an example of the present disclosure, when a communication failure occurs at a terminal, the terminal may send coexistence interference indication information to a network device to indicate whether the communication failure is caused by a coexistence interference or not, such that the network device may adopt a corresponding network optimization method for network optimization.

In some examples of the present disclosure, when the communication failure occurs at the terminal, the terminal may send the coexistence interference indication information for indicating whether the coexistence interference is existed to the network device. In other words, no matter whether the terminal determines the communication failure is caused by the coexistence interference, the terminal just needs to determine whether the coexistence interference is existed when the communication failure occurs, and reports to the network device whether the coexistence interference occurs at the terminal through the coexistence interference indication information.

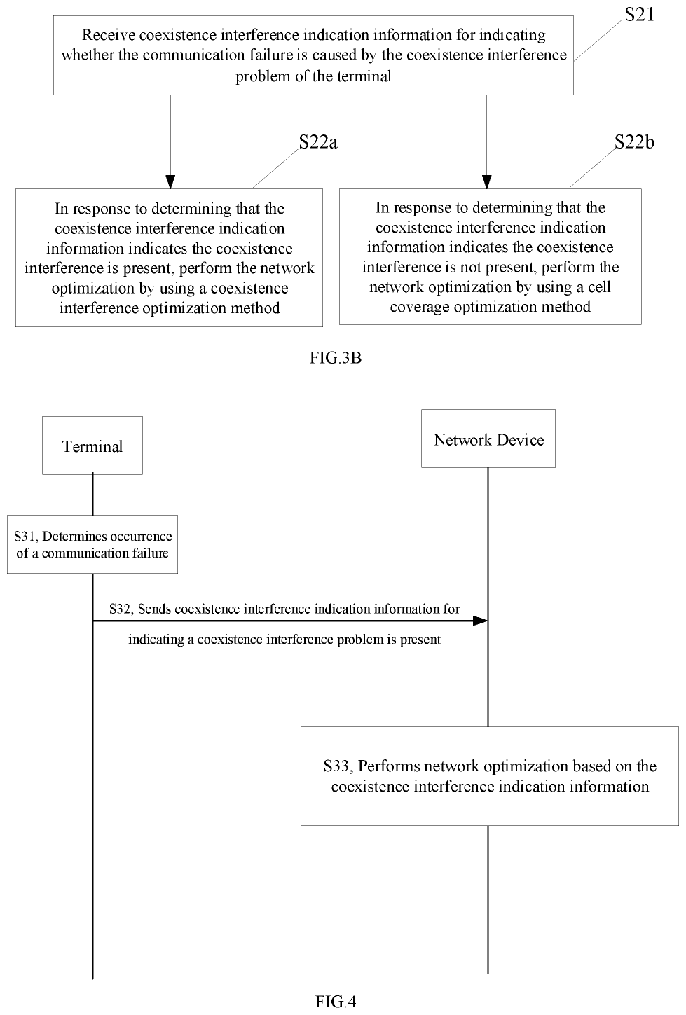

FIG. 3A is a flowchart illustrating a communication failure processing method according to an example of the present disclosure. As shown in FIG. 3A, the communication failure processing method is applied to a network device and includes the following steps.

At step S21, coexistence interference indication information is received, where the coexistence interference indication information is used to indicate a communication failure is caused by a coexistence interference problem of a terminal.

At step S22, a network optimization is performed based on the coexistence interference indication information.

In an example of the present disclosure, when a communication failure occurs, the network device may receive the coexistence interference indication information indicating that the communication failure is caused by a coexistence interference from the terminal and may further perform a corresponding network optimization method for network optimization.

In some examples of the present disclosure, when a communication failure occurs, the terminal may send to the network device the coexistence interference indication information to indicate whether the communication failure is caused by the coexistence interference problem. The communication failure processing method applied to the network device corresponds to steps shown in FIG. 3B.

At step S21, coexistence interference indication information is received, where the coexistence interference indication information is used to indicate whether the communication failure is caused by the coexistence interference problem of the terminal.

At step S22a, in response to determining that the coexistence interference indication information indicates the coexistence interference is existed, the network optimization is performed by using a coexistence interference optimization method.

At step S22b, in response to determining that the coexistence interference indication information indicates the coexistence interference is not present, the network optimization is performed by using a cell coverage optimization method.

In an example of the present disclosure, when a communication failure occurs, the network device receives the coexistence interference indication information and determines whether the communication failure is caused by the coexistence interference or by a cell coverage problem based on the coexistence interference indication information. When the coexistence interference indication information represents the coexistence interference problem is existed, the network device performs the network optimization by the coexistence interference optimization method. When the coexistence interference indication information represents the coexistence interference problem is not present, the network device performs the network optimization by the cell coverage optimization method.

The communication failure processing method mentioned in the above examples will be described below in combination with practical application.

In an example of the present disclosure, when a communication failure occurs at a terminal, the terminal device may send a communication failure report to a network device. In some examples, the terminal may send coexistence interference indication information based on the communication failure report sent to the network device so as to indicate that the communication failure occurs at the terminal due to the coexistence interference. In some other examples, the terminal may send the coexistence interference indication information based on the communication failure report sent to the network device, and if the network device does not receive the coexistence interference indication information in the communication failure report, the network device may determine the communication failure is not caused by the coexistence interference. In still other examples, the terminal may send coexistence interference indication information based on the communication failure report sent to the network device, so as to indicate whether a coexistence interference problem is existed when the communication failure occurs.

The following examples are described: a terminal may send coexistence interference indication information based on a communication failure report sent to a network device to indicate a communication failure occurs at the terminal due to a coexistence interference. Those skilled in the art may understand that other examples may also use the similar manner, which is not limited herein.

In an example of the present disclosure, based on different communication problems, different communication failure reports may be used to send coexistence interference indication information.

In an example, when a communication failure occurring at a terminal is a random access failure, the communication failure report may be a random access report or a connection establishment failure report. The network device receives the coexistence interference indication information through the random access report or the connection establishment failure report. The random access failure may be understood as a communication problem occurring when the terminal in an idle state or an inactive state initiates a random access procedure. Furthermore, the random access procedure may be a connection establishment procedure/a connection resume procedure/a connection reestablishment procedure/a position update procedure etc. involved in data transmission performed by the terminal in an idle state or an inactive state so as to perform an On-Demand SI request procedure.

The random access report or the connection establishment failure report may be carried in one or more of a connection establishment completion message, a connection resume completion message and an information response message of the terminal. In some examples, when a communication failure occurring at the terminal is a Radio Link Failure (RLF), the communication failure report may be a RLF report. A RLF problem is a RLF problem occurring at the terminal in a connected state. The terminal may carry coexistence interference indication information indicating the communication failure is caused by a coexistence interference in the RLF report. The network device receives the RLF report from the terminal to receive and determine the coexistence interference indication information based on the RLF report.

In an example of the present disclosure, based on the fact that the RLF is a Master Cell Group (MCG) RLF or a Secondary Cell Group (SCG) RLF, a message carrying the RLF report may be determined. On one hand, when the RLF occurring at the terminal in a connected state is an MCG RLF, the RLF report may be carried in one or more of a connection establishment completion message, a connection resume completion message and an information response message of the terminal. On the other hand, when the RLF occurring at the terminal in a connected state is an SCG RLF, the RLF report may be carried in SCG failure information.

In another example, when a communication failure occurring at the terminal is a small data packet transmission failure, the communication failure report may include a RLF report or a small data packet transmission failure report. The terminal may send the coexistence interference indication information through the RLF report or the small data packet transmission failure report. For example, the communication failure report of the terminal may be carried in the RLF report or a special report for small data packet transmission failure. The network device receives the coexistence interference indication information by receiving the RLF report or the small data packet transmission failure report. The small data packet transmission failure may be understood as a case that data packets are not successfully sent when the terminal in an idle state or an inactive state performs small data packet transmission. For example, a communication failure occurs when a Radio Link Control (RLC) reaches a maximum retransmission number.

In the above examples of the present disclosure, when a communication failure results from a coexistence interference, coexistence interference indication information representing an coexistence interference problem is existed may be sent through a communication failure report. In other words, in the examples of the present disclosure, when the communication failure is caused by the coexistence interference, the coexistence interference indication information representing the coexistence interference is existed may be sent.

Further, in examples of the present disclosure, a communication failure report sent by the terminal upon occurrence of a communication failure may include a cell signal measurement result of a cell subjected to communication failure. The cell signal measurement result may be a signal quality measurement result of the terminal when no coexistence interference occurs.

Furthermore, in an example of the present disclosure, the terminal may send capability indication information to the network device to indicate whether the terminal has a capability to send the coexistence interference indication information, such that the network device may analyze the coexistence interference indication information subsequently based on the capability indication information and make corresponding determination. For example, during capability reporting to the network device, the terminal may notify a network of whether it supports indicating the coexistence interference in the communication failure report. The network device may receive the capability indication information and determine whether the communication failure occurring at the terminal is caused by the coexistence interference problem based on the capability indication information. In this way, when the communication failure report does not include the coexistence interference indication information, the network device may determine whether the terminal does not support indicating the coexistence interference in the communication failure report or whether the communication failure does not result from the coexistence interference.

FIG. 4 is a flowchart illustrating a communication failure processing method according to an example of the present disclosure. As shown in FIG. 4, the communication failure processing method may be applied to an interaction between a terminal and a network device. The method includes the following steps.

At step S31, the terminal determines occurrence of a communication failure.

At step S32, the terminal sends coexistence interference indication information to the network device, where the coexistence interference indication information is used to indicate a coexistence interference problem is existed. The network device receives the coexistence interference indication information from the terminal.

At step S33, the network device performs network optimization based on the coexistence interference indication information.

In some examples, the terminal may send the coexistence interference indication information base on the communication failure report sent to the network device to indicate a communication failure occurs at the terminal is caused by a coexistence interference. In some other examples, the terminal may send the coexistence interference indication information base on the communication failure report sent to the network device, and if the network device does not receive the coexistence interference indication information in the communication failure report, the network device may determine the communication failure does not result from the coexistence interference. In still other examples, the terminal may send coexistence interference indication information based on the communication failure report sent to the network device, so as to indicate whether the coexistence interference problem is existed upon occurrence of the communication failure at the terminal.

When the communication failure results from the coexistence interference, a network optimization may be performed by using a coexistence interference optimization method. When the communication failure does not result from the coexistence interference, the network optimization may be performed by using a cell coverage optimization method.

In the examples of the present disclosure, for the execution process in which the terminal and the network device implement the communication failure processing method in an interactive manner, reference may be made to the descriptions of relevant examples in which the terminal and the network device implement the communication failure processing method, and no redundant descriptions are made here.

In the communication failure processing method provided by the examples of the present disclosure, when a communication failure occurs at a terminal, the terminal may send coexistence interference indication information to report whether an interference problem is existed. A network device may receive the coexistence interference indication information from the terminal and determine whether the communication failure results from a coexistence interference problem based on the coexistence interference indication information, such that the network device may perform network optimization by using a corresponding network optimization method. When the coexistence interference indication information represents the coexistence interference problem is existed, a network optimization may be performed by using a coexistence interference optimization method. When the coexistence interference indication information represents the coexistence interference problem is not present, the network optimization may be performed by using a cell coverage optimization method.

Based on the same idea, some examples of the present disclosure further provide a communication failure processing apparatus.

It may be understood that, in order to achieve the above functions, the communication failure processing apparatus provided by the examples of the present disclosure include corresponding hardware structure and/or software modules for performing various functions. In combination with units and algorithm steps disclosed in the examples of the present disclosure, the examples of the present disclosure can be implemented by hardware or combination of hardware and computer software. Performing a particular function by hardware or by driving the hardware using the computer software depends on specific application and design constraint condition of the technical solution. Those skilled in the art may implement the described function for each specific application by a different method, but such implementation shall not be understood as exceeding the scope of the technical solution of the examples of the present disclosure.

FIG. 5 is a block diagram illustrating a communication failure processing apparatus according to an example of the present disclosure. As shown in FIG. 5, the communication failure processing apparatus 100 is applied to a terminal. The apparatus includes a determining unit 101 and a sending unit 102.

The determining unit 101 is configured to determine occurrence of a communication failure; the sending unit 102 is configured to send coexistence interference indication information, where the coexistence interference indication information is used to indicate the communication failure is caused by a coexistence interference problem.

In an implementation, the sending unit 102 sends the coexistence interference indication information through a communication failure report.

In another implementation, the terminal is in an idle state or an inactive state, and the communication failure refers to a communication failure that occurs when the terminal initiates a random access.

In another implementation, the communication failure report may be a random access report or a connection establishment failure report; and the communication failure report may be carried in a connection establishment completion message, or the communication failure report may be carried in a connection resume completion message, or the communication failure report may be carried in an information response message of the terminal.

In another implementation, the terminal is in an active state and the communication failure may be a radio link failure.

In another implementation, the communication failure report may be a radio link failure report.

In another implementation, the radio link failure report is a radio link failure report of a master cell group, and the radio link failure report may be carried in an establishment completion message, or the radio link failure report may be carried in a connection resume completion message, or the radio link failure report may be carried in an information response message of the terminal; or, the radio link failure report is a radio link failure report of a secondary cell group, and the radio link failure report may be carried in failure information on the secondary cell group.

In another implementation, the communication failure may be a small data packet transmission failure.

In another implementation, the communication failure report may be a radio link failure report or a small data packet transmission failure report.

In another implementation, the communication failure report may further include a signal quality measurement result when no coexistence interference problem occurs.

In another implementation, the sending unit 102 in the examples of the present disclosure is further configured to:

send capability indication information, where the capability indication information is used to indicate whether the terminal has a capability to support sending the coexistence interference indication information.

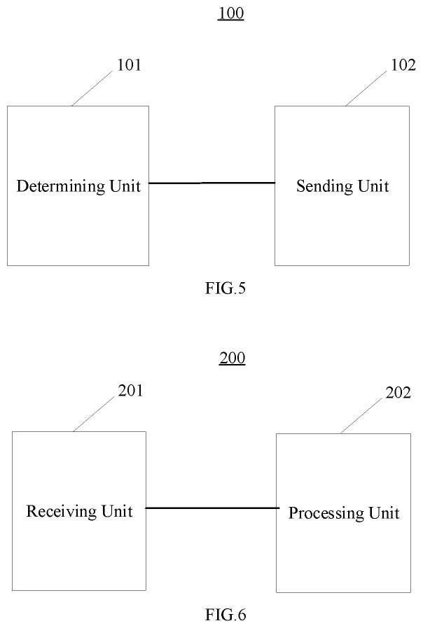

FIG. 6 is a block diagram illustrating a communication failure processing apparatus according to an example of the present disclosure. As shown in FIG. 6, the communication failure processing apparatus 200 is applied to a network device. The apparatus includes a receiving unit 201 and a processing unit 202.

The receiving unit 201 is configured to receive coexistence interference indication information upon occurrence of a communication failure, where the coexistence interference indication information is used to indicate the communication failure is caused by a coexistence interference problem of a terminal. The processing unit 202 is configured to perform network optimization according to the coexistence interference indication information.

When the coexistence interference indication information represents the coexistence interference problem is existed, the processing unit 202 may perform network optimization by using a coexistence interference optimization method. When the coexistence interference indication information represents the coexistence interference problem is not present, the processing unit 202 may perform network optimization by using a cell coverage optimization method.

In an implementation, the receiving unit 201 is configured to receive the coexistence interference indication information through a communication failure report.

In another implementation, the terminal is in an idle state or inactive state and the communication failure refers to a communication failure that occurs when the terminal initiates random access.

In another implementation, the communication failure report may be a random access report or a connection establishment failure report; and the communication failure report may be carried in a connection establishment completion message, or the communication failure report may be carried in a connection resume completion message, or the communication failure report may be carried in an information response message of the terminal.

In another implementation, the terminal is in an active state and the communication failure may be a radio link failure.

In another implementation, the communication failure report may be a radio link failure report.

In another implementation, the radio link failure report is a radio link failure report of a master cell group, and the radio link failure report may be carried in an establishment completion message, or the radio link failure report may be carried in a connection resume completion message, or the radio link failure report may be carried in an information response message of the terminal; or, the radio link failure report is a radio link failure report of a secondary cell group, and the radio link failure report may be carried in failure information on the secondary cell group.

In another implementation, the communication failure may be a small data packet transmission failure.

In another implementation, the communication failure report may be a radio link failure report or a small data packet transmission failure report.

In another implementation, the communication failure report may further include a signal quality measurement result when no coexistence interference problem occurs.

In another implementation, the receiving unit 201 may further be configured to: receive capability indication information, where the capability indication information is used to indicate whether the terminal has a capability to support sending the coexistence interference indication information.

The specific manner in which each unit or module in the apparatus of the above examples of the present disclosure performs operations has already been described in details in the method examples above, and thus will not be repeated herein.

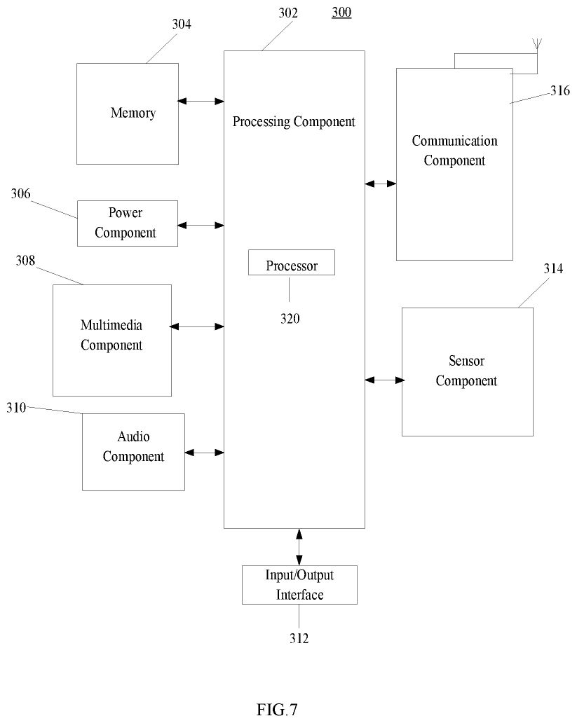

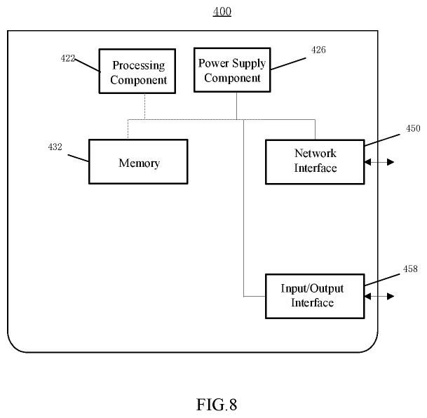

FIG. 7 is a block diagram of a communication failure processing apparatus 300 according to an example of the present disclosure. For example, the apparatus 300 may be a mobile phone, a computer, a digital broadcast terminal, a message transceiver, a game console, a tablet device, a medical device, a fitness device, a personal digital assistant, and the like.

As shown in FIG. 7, the apparatus 300 may include one or more of the following components: a processing component 302, a memory 304, a power component 306, a multimedia component 308, an audio component 310, an input/output (I/O) interface 312, a sensor component 314 and a communication component 316.

The processing component 302 generally controls overall operations of the apparatus 300, such as operations associated with display, phone calls, data communications, camera operations, and recording operations. The processing component 302 may include one or more processors 320 to execute instructions to complete all or part of the steps of the above methods. In addition, the processing component 302 may include one or more modules which facilitate the interaction between the processing component 302 and other components. For example, the processing component 302 may include a multimedia module to facilitate the interaction between the multimedia component 308 and the processing component 302.

The memory 304 is configured to store various types of data to support the operation of the apparatus 300. Examples of such data include instructions for any application or method operated on the apparatus 300, contact data, phonebook data, messages, pictures, videos, and so on. The memory 304 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power component 306 supplies power for different components of the apparatus 300. The power component 306 may include a power supply management system, one or more power supplies, and other components associated with generating, managing and distributing power for the apparatus 300.

The multimedia component 308 includes a screen that provides an output interface between the apparatus 300 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 308 includes a front camera and/or a rear camera. When the apparatus 300 is in an operation mode, such as a shooting mode or a video mode, the front camera and/or the rear camera may receive external multimedia data. Each of the front and rear cameras may be a fixed optical lens system or have a focal length and an optical zoom capability.

The audio component 310 is configured to output and/or input audio signals. For example, the audio component 310 includes a microphone (MIC) configured to receive an external audio signal when the apparatus 300 is in an operation mode, such as a call mode, a recording mode, and a voice recognition mode. The received audio signal may be further stored in the memory 304 or transmitted via the communication component 316. In some examples, the audio component 310 also includes a loudspeaker for outputting an audio signal.

The I/O interface 312 provides an interface between the processing component 302 and a peripheral interface module which may be a keyboard, a click wheel, a button, or the like. These buttons may include, but are not limited to a home button, a volume button, a start button, and a lock button.

The sensor component 314 includes one or more sensors for providing a status assessment in various aspects to the apparatus 300. For example, the sensor component 314 may detect an open/closed state of the apparatus 300, and the relative positioning of components, for example, the component is a display and a keypad of the apparatus 300. The sensor component 314 may also detect a change in position of the apparatus 300 or a component of the apparatus 300, the presence or absence of a user in contact with the apparatus 300, the orientation or acceleration/deceleration of the apparatus 300 and a change in temperature of the apparatus 300. The sensor component 314 may include a proximity sensor configured to detect the presence of nearby objects without any physical contact. The sensor component 314 may also include a light sensor, such as a CMOS or CCD image sensor, for use in imaging applications. In some examples, the sensor component 314 may also include an acceleration sensor, a gyro sensor, a magnetic sensor, a pressure sensor, or a temperature sensor.

The communication component 316 is configured to facilitate wired or wireless communication between the apparatus 300 and other devices. The apparatus 300 may access a wireless network based on a communication standard, such as WiFi, 2G or 3G, or a combination thereof. In an example, the communication component 316 receives broadcast signals or broadcast associated information from an external broadcast management system via a broadcast channel. In an example, the communication component 316 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the apparatus 300 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above methods.

In an example, there is also provided a non-transitory computer readable storage medium including instructions, such as a memory 304 including instructions, where the instructions are executable by the processor 320 of the apparatus 300 to perform the method as described above. For example, the non-transitory computer readable storage medium may be a read only memory (ROM), random access memory (RAM), CD-ROM, magnetic tape, floppy disk and optical data storage device and the like.

FIG. 8 is a block diagram illustrating an apparatus 400 for transmitting configuration activation according to an example of the present disclosure. For example, the apparatus 400 may be provided as a network device. With reference to FIG. 8, the apparatus 400 may include a processing component 422 and further include one or more processors and memory resources represented by a memory 432 for storing instructions executable by the processing component 422, for example, an application program. The application program stored in the memory 432 may include one or more modules with each corresponding to one set of instructions. Furthermore, the processing component 422 is configured to execute the instructions to implement the above method.

The apparatus 400 further includes one power supply component 426 configured to execute power management for the apparatus 400, one wired or wireless network interface 450 configured to connect the apparatus 400 to a network, and one input/output (I/O) interface 458. The apparatus 400 may be operated based on an operating system stored in the memory 432, such as Windows Server™, Mac OS X™, Unix™, Linux™ and FreeBSD™.

In an example, there is also provided a non-transitory computer readable storage medium including instructions, such as a memory 404 including instructions, where the instructions are executable by a processor 420 of the apparatus 400 to perform the method as described above. For example, the non-transitory computer readable storage medium may be a read only memory (ROM), random access memory (RAM), CD-ROM, magnetic tape, floppy disk and optical data storage device and the like.

It is further understood that “plurality” in the present disclosure refers to two or more and the quantifiers have the similar meanings. The “and/or” is used to describe association relationship of associated objects and represent three relationships, for example, A and/or B may represent that A exists alone, both A and B exist at the same time, and B exists alone. The character “/” generally represents an “or” relationship of the objects associated back and forth. The terms “a”, “said” and “the” in singular forms are also meant to include plural form, unless otherwise clearly stated in the context.

It is to be understood that although different information may be described using the terms such as first, second, third, etc. in the present disclosure, this information should not be limited to these terms. These terms are used only to distinguish the same type of information from each other rather than represent a specific sequence or an importance degree. Actually, the expressions such as “first” and “second” may be interchanged. For example, without departing from the scope of the present disclosure, the first information may also be referred to as the second information and similarly, the second information may also be referred to as the first information.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

It may be understood that operations are described in a specific sequence in the accompanying drawings in the examples of the present disclosure, it shall not be understood as requiring these operations to be performed in the shown specific sequence or serial sequence, or all operations shown to be performed to achieve a desired result. In a specific environment, multi-task processing and parallel processing are possible and may also be advantageous.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as examples only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A method for processing communication failure comprising:
determining, by a terminal, occurrence of a communication failure; and
sending, by the terminal, coexistence interference indication information for indicating the communication failure related to by a coexistence interference problem.

2. The method of claim 1, wherein sending the coexistence interference indication information comprises:
sending the coexistence interference indication information through a communication failure report.

3. The method of claim 1,
wherein the terminal is in an idle state or an inactive state, and
wherein the communication failure comprises a communication failure that occurs when the terminal initiates random access.

4. The method of claim 3,
wherein the communication failure report is a random access report or a connection establishment failure report, and
wherein the communication failure report is carried in a connection establishment completion message, or the communication failure report is carried in a connection resume completion message, or the communication failure report is carried in an information response message of the terminal.

5. The method of claim 1,
wherein the terminal is in an active state, and
wherein the communication failure is a radio link failure.

6. The method of claim 5, wherein the communication failure report is a radio link failure report.

7. The method of claim 6,
wherein the radio link failure report is a radio link failure report of a master cell group, and the radio link failure report is carried in a connection establishment completion message, or the radio link failure report is carried in a connection resume completion message, or the radio link failure report is carried in an information response message of the terminal;
or,
wherein the radio link failure report is a radio link failure report of a secondary cell group, and the radio link failure report is carried in failure information on the secondary cell group.

8. The method of claim 1, wherein the communication failure is a small data packet transmission failure.

9. The method of claim 8, wherein the communication failure report is a radio link failure report or a small data packet transmission failure report.

10. The method of claim 2, wherein the communication failure report further comprises a signal quality measurement result when no coexistence interference problem occurs.

11. The method of claim 1, further comprising:
sending capability indication information for indicating whether the terminal supports sending the coexistence interference indication information.

12. A method for processing communication failure comprising:
receiving, by a network device, coexistence interference indication information for indicating a communication failure related to a coexistence interference problem of a terminal; and
performing, by the network device, a network optimization based on the coexistence interference indication information.

13. The method of claim 12, wherein receiving the coexistence interference indication information comprises:
receiving the coexistence interference indication information through a communication failure report.

14.-17. (canceled)

18. A communication failure processing apparatus, being applied to a terminal, and comprising:
a processor;
a memory storing processor-executable instructions;
wherein, when the processor executes the processor-executable instructions, the processor is configured to perform operations comprising:
determining occurrence of a communication failure; and
sending coexistence interference indication information for indicating the communication failure related to a coexistence interference problem.

19. A communication failure processing apparatus, being applied to a network device, and comprising:
a processor;
a memory storing processor-executable instructions;
wherein, when the processor executes the processor-executable instructions, the processor is configured to perform the communication failure processing method according to claim 12.

20. A non-transitory computer readable storage medium, wherein when instructions in the storage medium are executed by a processor in a mobile terminal, the mobile terminal is caused to perform the communication failure processing method according to claim 1.

21. A non-transitory computer readable storage medium, wherein when instructions in the storage medium are executed by a processor in a network device, the network device is caused to perform the communication failure processing method according to claim 12.

22. The communication failure processing apparatus of claim 18, wherein sending the coexistence interference indication information comprises:
sending the coexistence interference indication information through a communication failure report.

23. The communication failure processing apparatus of claim 18,
wherein the terminal is in an idle state or an inactive state, and
wherein the communication failure comprises a communication failure that occurs when the terminal initiates random access.

24. The communication failure processing apparatus of claim 23,
wherein the communication failure report is a random access report or a connection establishment failure report, and
wherein the communication failure report is carried in a connection establishment completion message, or the communication failure report is carried in a connection resume completion message, or the communication failure report is carried in an information response message of the terminal.
